(19) United States
(12) Patent Application Publication
(10) Pub. No.: US 2004/0067108 A1
(43) Pub. Date: Apr. 8, 2004

(54) Device and method for changing lines

(76) Inventor: Hans Joachim Bayer, Ettlingen/Oberweier (DE)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 10/250,355

(22) PCT Filed: Dec. 21, 2001
(86) PCT No.: PCT/EP01/15270

(30) Foreign Application Priority Data
Dec. 29, 2000 (DE) 100655327

(51) Int. Cl. F16L 55/18; F16L 55/44

(52) U.S. Cl. 405/184.1; 405/184.3; 138/98; 138/99

(57) ABSTRACT

The invention relates to a device for replacing lines without excavation, comprising an annular overdrilling head and a drive for rotating a front module arranged on the overdrilling head.

The invention relates to a device and a method for replacing lines without excavation, with the aid of an annular overdrilling head, which is moved over the line and is driven forward in the ground, and claims the priority of German patent application 100 65 532.7 to the content of which reference is made.

A device of the generic type is disclosed by DE 33 31 291 C2. This describes an open tubular drilling device which, for example, is placed on an underground cable and driven forward underground along the cable by the cutting force of high pressure nozzles. As a result, an annular space is produced around the cable, which facilitates or permits the removal of the cable from the ground. The device is guided by a drilling string and therefore not moved forward independently.

By contrast, DE 195 04 484 C1 discloses an open tubular drilling device which is driven through the ground by means of a linkage.

As a rule, devices of this type operate with a flushing device which comprises nozzles which are arranged on the head of the tubular forward drive element and to which flushing medium is applied.

Using the aforementioned devices, good results are achieved if no relatively large obstacles have to be overcome in the ground, rather the line to be freed is substantially free of branches, sockets or clips and, in the ground, no stones, fragments of pipe or capping stones have to be overcome.

In practice, however, the aforementioned obstacles are to be met frequently and constitute obstacles which cannot be overcome by the drilling devices described.

It is therefore an object of the invention to provide a drilling device and a drilling method which widens the field of use of known drilling devices and which is capable of overcoming specific obstacles present in the ground, which are virtually always to be expected.

The object of the invention is achieved by the subject matter of the independent claims. Advantageous refinements are the subject matter of the subclaims.

The drilling device according to the invention has a tubular drilling head (overdrilling head in the following text) and is configured in such a way that any obstacles present in the ground are separated from the pipe to be freed or the line to be freed or destroyed, by the overdrilling head carrying out a rotation, at least in its front region (front module in the following text).

The overdrilling head is preferably driven forward in the ground by a thrust linkage. In this case, it is constructed in such a way that the transition region to the linkage is characterized by a geometry which is free of weak points.

In a particularly preferred embodiment, the front module is mounted on the overdrilling head such that it can rotate and is provided with a turbine drive. In this case, a turbine rotor can be arranged on the front module, this can be followed behind by further turbine rotors arranged to run in opposite directions and a nozzle insert which is arranged on the body of the overdrilling head and which is preferably supplied via the linkage with liquid in order to drive the turbine rotors. The nozzle insert can be variable, in order to be suitable for different torque and rotational speed requirements. Furthermore, between the nozzle insert and the first turbine rotor, a steering element, for example in the form of a steering plate, can be arranged which, depending on the alignment, deflects the nozzle jet in one direction or the other and in this way effects rotation of the front module in one direction or the other. The steering plate can be constructed in such a way that it reacts to flushing surges and thus permits the direction of rotation to be changed.

The turbine is preferably constructed as a free-jet turbine, for example of the modified Pelton type, as is conventional in turbine drilling in the deep-drilling sector, or as a beveled internal gear of a gearbox element, in front of which an opposing gearwheel with attached turbine is fitted orthogonally. In the latter case, the driving force for the front module is produced by a permanently installed turbine rotor.

At the end, the overdrilling head can be fitted with tools, such as hard metal pins, hard metal plates, circular shank chisels, industrial diamonds, wear-protected welded tracks with grit, removal grooves or transverse notches for cutting or milling or severing obstacles.

The overdrilling head can, moreover, have nozzles arranged at the end for clear-flushing the ground and for cooling the drilling head. These can be formed as high pressure nozzles arranged at a specific angle.

In the following text, the invention will be explained in more detail using an exemplary embodiment illustrated in the drawing, in which:

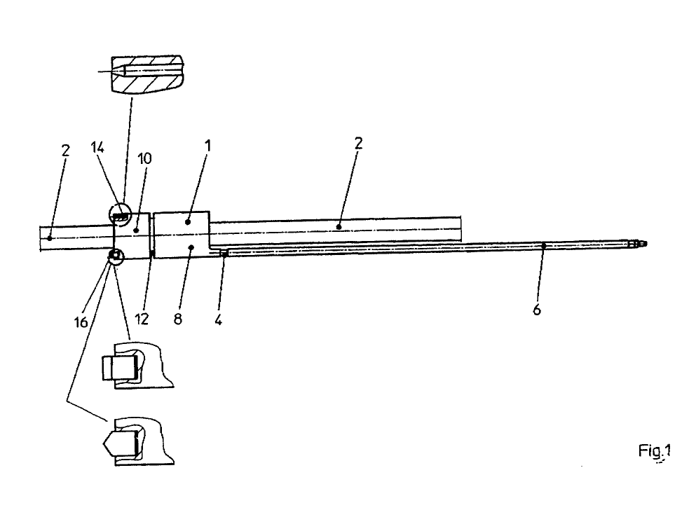

FIG. 1 shows an overdrilling head according to the invention with front module on an old line;

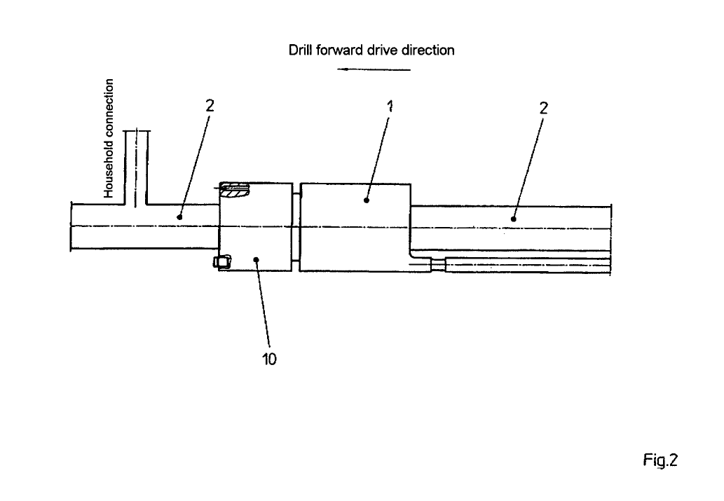

FIG. 2 shows the overdrilling head of FIG. 1 when severing a branch;

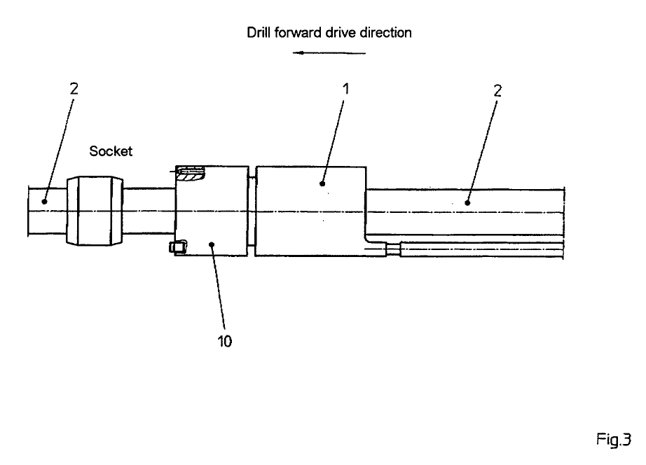

FIG. 3 shows the overdrilling head of FIG. 1 when removing a socket; and

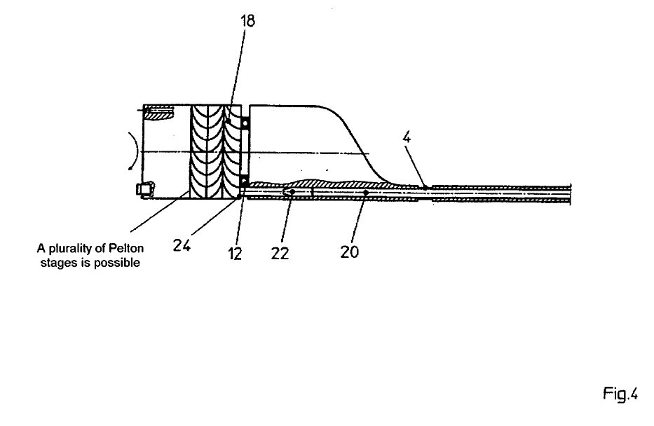

FIG. 4 shows an illustration of the drive of the front module.

In FIGS. 1 to 3, the overdrilling head 1 is illustrated on an old pipe 2 and, via a screw connection 4, is connected to a thrust linkage 6 running along the old pipe.

The overdrilling head has a body 8 and a front module 10, which is connected to the body 8 via a bearing 12 such that it can rotate. The transition between body 8 and drilling linkage 6 is characterized by a geometry that is free of weak points.

At the end, the front module 10 has high pressure nozzles 14 and/or cutting tools of hard metal or PCD with different geometries.

The front module 10 is set rotating by a drive. The drive comprises at least one free-jet turbine 18 which is arranged on the body side on the inside of the front module and behind which a plurality of turbine rotors running in opposite directions can be connected, with which a nozzle insert 22 arranged at the end of a media channel 20 running in the drilling linkage and in the body is aligned in order to form a free jet. The nozzle jet firstly strikes an adjustable steering plate 24 and then, depending on the position of the steering plate, the corresponding side of the front turbine blades of the free-jet turbine 18 in the front module.

During forward drive, the front module 10 is set rotating with the aid of the drive via the pressure medium running in the media channel 20, so that obstacles such as house connections (see FIG. 2) or sockets (see FIG. 3) can be eliminated with the aid of the tools 16 arranged at the end of the front module 10.

The front module 10 is connected to the body 8 in an encompassing fitting means which accommodates a bearing 12.

In another embodiment, a beveled internal gear of a gearbox element is provided in the front module 10, in front of which an opposing internal gear with attached turbine is fitted orthogonally in the body 8. The first turbine rotor permanently installed in the body (or further turbine rotors) thus produces a torque which is transmitted to the front module by means of the gearbox.

1. A device for replacing lines without excavation, with an annular overdrilling head (1), characterized by a drive (18, 20, 22) for the rotation of the overdrilling head (1) or part of the overdrilling head (10).

2. The device as claimed in claim 1, characterized by a rotatable front module (10).

3. The device as claimed in claim 1 or 2, characterized by a thrust linkage connection.

4. The device as claimed in one of the preceding claims, characterized by a continuous geometry, free of weak points, of the connecting region for the thrust linkage connection, which permits a uniform introduction of force into the overdrilling head (1).

5. The device as claimed in one of the preceding claims, characterized in that the overdrilling head (1) is formed as an annular flushing head.

6. The device as claimed in one of the preceding claims, characterized by a turbine drive (18, 20, 22) for the rotation of the front module (10).

7. The device as claimed in one of the preceding claims, characterized by a turbine drive (18, 20, 22) and a nozzle insert (22) aimed at the turbine rotor (18).

8. The device as claimed in one of the preceding claims, characterized by a turbine drive (18, 20, 22) comprising at least one turbine rotor (18) with a plurality of turbine rotors running in opposite directions and a nozzle insert (22) aimed at the first turbine rotor.

9. The device as claimed in one of the preceding claims, characterized by a sequence of drilling turbine rotors running in opposite directions and belonging to turbine drilling heads for deep drilling.

10. The device as claimed in one of the preceding claims, characterized by a variable nozzle insert (22).

11. The device as claimed in one of the preceding claims, characterized by a steering element (24) arranged between the nozzle insert (22) and the turbine rotor/the turbine rotors (18).

12. The device as claimed in one of the preceding claims, characterized by a free-jet turbine (18, 20, 22).

13. The device as claimed in one of the preceding claims, characterized by a Pelton turbine (18, 20, 22).

14. The device as claimed in one of the preceding claims, characterized by an internal gear arranged on the body of the overdrilling head (1) and belonging to a gearbox element, in front of which an opposing internal gear with attached turbine is fitted orthogonally.

15. The device as claimed in one of the preceding claims, characterized in that tools (16) for severing or destroying obstacles are arranged at the end.

16. The device as claimed in one of the preceding claims, characterized by a nozzle complement (14) in the front region of the overdrilling head (1) for clear-flushing the ground and and/or cooling the drilling head.

17. A method for replacing lines without excavation, comprising an annular overdrilling head, which is pushed onto the line and driven forward, characterized in that the drilling head or part of the drilling head is rotated.
